(19) United States
(12) Patent Application Publication
(10) Pub. No.: US 2025/0159062 A1
(43) Pub. Date: May 15, 2025

(54) SYSTEMS AND METHODS FOR NATIVELY GENERATING A PROTOCOL

(71) Applicant: Ad Hoc Labs Inc., Los Angeles, CA (US)

(72) Inventors: William CARTER, Los Angeles, CA (US); Greg COHN, Los Angeles, CA (US); Gabe HAACK, Pasadena, CA (US); Robert KAZIMIROFF, Pasadena, CA (US); Jessalyn JOHNSON, Lake Elsinore, CA (US); Thomas VU, Columbus, OH (US); Adam AKE, Honolulu, HI (US); Giancarlo MUSETTI, Buenos Aires (AR); Daniel GROOT, Washington, DC (US); Tim HENDERSON, Denver, CO (US)

(21) Appl. No.: 18/945,246

(22) Filed: Nov. 12, 2024

Related U.S. Application Data
(60) Provisional application No. 63/598,344, filed on Nov. 13, 2023.

(51) Int. Cl. H04L 69/00; G06N 20/00; H04L 67/306

(52) U.S. Cl. CPC H04L 69/26; G06N 20/00; H04L 67/306

(57) ABSTRACT

Described are systems and methods for natively generating a first protocol, including receiving, via a user device, a first transmission and first transmission data, wherein the first transmission is at least one of a call, a voicemail, a text message, an audio message, or a video message, determining, via a first trained machine learning model, the first protocol based on the first transmission and the first transmission data, the first trained machine learning model having been trained to determine one or more protocols using training transmissions and training transmission data, generating, via the first trained machine learning model, a first responsive output based on the first protocol, and transmitting, via the user device, the first responsive output to a third-party device.

### CROSS-REFERENCE TO RELATED APPLICATION(S)

This application claims the benefit of pending U.S. Provisional Patent Application No. 63/598,344, filed on Nov. 13, 2023, which is incorporated herein by reference in its entirety.

### TECHNICAL FIELD

Various techniques of this disclosure relate generally to natively generating a protocol and, more particularly, to systems and methods for generating responsive outputs based on at least one generated protocol.

### BACKGROUND

Conventional methods of transmission analysis often involve piecemeal analysis across systems or limited analysis of available data points. While important data may be available in large quantities, conventional methods often fail to take all of this data into account when conducting analysis. As such, these systems often fail to provide the most accurate and up-to-date analysis.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for natively generating a protocol.

In one aspect, a method for natively generating a first protocol is disclosed. The method may include receiving, via a user device, a first transmission and first transmission data, wherein the first transmission is at least one of a call, a voicemail, a text message, an audio message, or a video message; determining, via a first trained machine learning model, the first protocol based on the first transmission and the first transmission data, the first trained machine learning model having been trained to determine one or more protocols using training transmissions and training transmission data; generating, via the first trained machine learning model, a first responsive output based on the first protocol; and transmitting, via the user device, the first responsive output to a third-party device.

In another aspect, a system for natively generating a first protocol is disclosed. The system may include at least one memory storing instructions, and at least one processor configured to execute the instructions to perform operations. The operations may include receiving, via a user device, a first transmission and first transmission data, wherein the first transmission is at least one of a call, a voicemail, a text message, an audio message, or a video message; determining, via a first trained machine learning model, the first protocol based on the first transmission and the first transmission data, the first trained machine learning model having been trained to determine one or more protocols using training transmissions and training transmission data; generating, via the first trained machine learning model, a first responsive output based on the first protocol; and transmitting, via the user device, the first responsive output to a third-party device.

In another aspect, a non-transitory computer-readable medium storing instructions that, when executed by a processor, perform operations for natively generating a first protocol is disclosed. The operations may include receiving, via a user device, a first transmission and first transmission data, wherein the first transmission is at least one of a call, a voicemail, a text message, an audio message, or a video message; determining, via a first trained machine learning model, the first protocol based on the first transmission and the first transmission data, the first trained machine learning model having been trained to determine one or more protocols using training transmissions and training transmission data; generating, via the first trained machine learning model, a first responsive output based on the first protocol; and transmitting, via the user device, the first responsive output to a third-party device.

It is to be understood that both the foregoing general description and the following detailed description are exemplary and explanatory only and are not restrictive of the disclosed techniques, as claimed.

### BRIEF DESCRIPTION OF THE DRAWINGS

The accompanying drawings, which are incorporated in and constitute a part of this specification, illustrate various exemplary techniques and together with the description, serve to explain the principles of the disclosed techniques.

FIG. 1 depicts an exemplary environment for natively generating a protocol, according to one or more techniques.

FIGS. 2A-2B depict an exemplary method for natively generating the protocol, according to one or more techniques.

FIG. 3 depicts an exemplary method for training a machine learning model, according to one or more techniques.

FIG. 4 depicts a simplified functional block diagram of a computer, according to one or more techniques.

### DETAILED DESCRIPTION OF TECHNIQUES

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described techniques. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In an exemplary use case, a native artificial intelligence “assistant” may dynamically interact with a third-party user. The third-party user may initiate a call (e.g. via a third-party device) to a user (e.g., via a user device). The call and call data may be analyzed by the native assistant to determine a protocol for handling the call. The assistant may classify the call with one or more classifications/sub-classifications/tags/labels, such as “spam,” “junk,” “authentic,” “personal call,” “emergency,” “spouse,” “friend,” “business call,” “medical results,” “occasional contact,” etc. using a trained machine learning model. The machine learning model may apply a plurality of classifications/tags whenever a determined confidence goes beyond a predetermined threshold. Each classification/tag may be stored with an associated confidence level. Based on various data points, classifications/tags applied and the confidence level of each, the call data, user preferences, etc., the native assistant may determine and/or generate the protocol and at least one responsive output. For example, where a third-party user is classified as “authentic,” the native assistant may answer a call from the third-party user and interact with the third-party user. In another example, where a third-party user is classified as “spam,” the native assistant may decline a call from the third-party user and save the phone number as “spam.” In another example, where a third-party is classified as an “occasional contact,” the native assistant may allow the call to go through, but only after screening questions to determine a level of importance. As additional input is received from the third-party user, classifications/tags, and a confidence associated therewith, may be updated. The protocols may subsequently be updated as well, which may cause a change to the planned responsive output of the assistant.

While the examples above involve natively generating at least one protocol, it should be understood that techniques according to this disclosure may be adapted to any suitable system, method, or configuration. Any of the techniques discussed herein may be actuated via a plug-in, application, Application Programming Interface (“API”), etc. For example, the techniques described herein may be adapted to an API available to any phone company, or a service by which calls, texts, etc. may be forwarded to this service for handling. It should also be understood that the examples above are illustrative only. The techniques and technologies of this disclosure may be adapted to any suitable activity. Presented below are various systems and methods for natively generating a protocol.

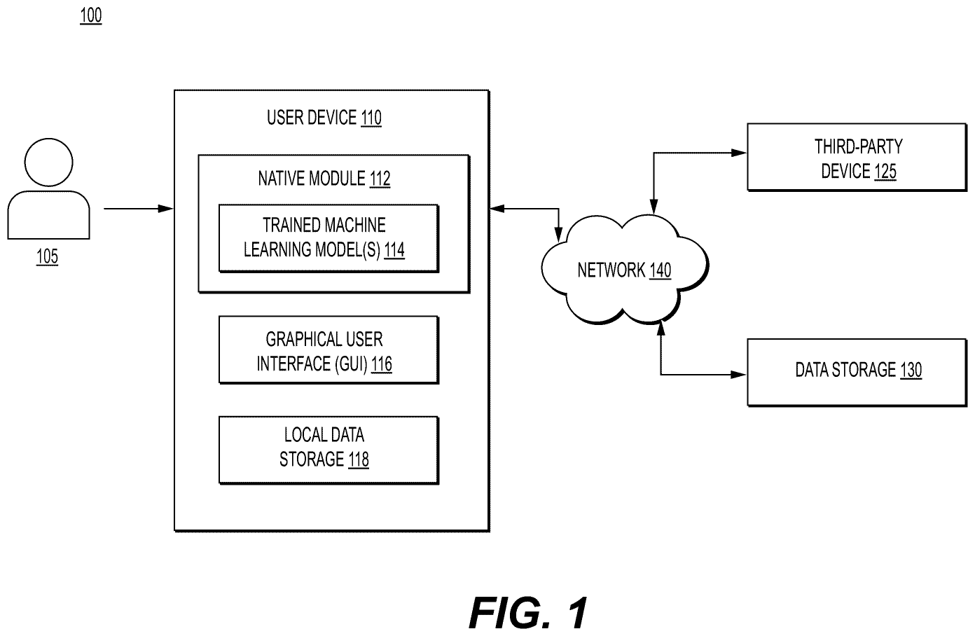

FIG. 1 depicts an example environment 100 that may be utilized with techniques presented herein. Environment 100 may include one or more aspects that may communicate with each other over a network 140, including, e.g., a user device 110, a third-party device 125, a data storage 130, etc. In some techniques, a user 105 may interact with a user device 110. User device 110 may be a computer system, e.g., a desktop computer, a laptop computer, a tablet, a smart cellular phone, a smart watch or other electronic wearable, etc. In some techniques, user device 110 may include native programming for implementing the techniques discussed herein.

User device 110 may include a native module 112, a graphical user interface (“GUI”) 116, or a local data storage 118. User device 110—or the one or more aspects of user device 110, e.g., native module 112, trained machine learning model(s) 114, GUI 116, local data storage 118, etc.—may be configured to obtain data from one or more aspects of environment 100. For example, user device 110 may be configured to receive data from native module 112, trained machine learning model(s) 114, GUI 116 (e.g., via one or more inputs from user 105), local data storage 118, third-party device 125, data storage 130, etc. User device 110 may be configured to transmit data to one or more aspects of environment 100, e.g., to native module 112, trained machine learning model(s) 114, GUI 116, local data storage 118, third-party device 125, data storage 130, etc.

Native module 112 may be configured to determine at least one protocol (e.g., a first protocol, a second protocol, etc.). The at least one protocol may include a generated plan for analyzing, responding, etc. to a transmission, which may be determined based on a categorization and/or sub-categorization of the transmission. For example, if the transmission is a text message, the at least one protocol may include how the text data or text metadata may be analyzed, analyzing the text data or text metadata, and determining a planned response to the text message.

In some techniques, native module 112 may be configured to determine the at least one protocol based on at least one of user preference data, a transmission (e.g., a first transmission, a second transmission, etc.), transmission data (e.g., first transmission data, second transmission data, etc.), at least one third-party response to at least one responsive output, etc. In some techniques, native module 112 may be configured to scrape the user preference data, the transmission, the transmission data, etc. from user device 110 or from a paired, connected, etc. device.

User preference data may include the preferences of the user (e.g., user 105) regarding the responsive output, as discussed in more detail below. The transmission may include at least one of a call, a voicemail, a text message, an audio message, a video message, etc. The transmission data may include at least one of call data, call metadata, voicemail data, voicemail metadata, text data, text metadata, audio data, audio metadata, video data, video metadata, static user data, static user metadata, dynamic user data, dynamic user metadata, general knowledge data, etc.

Static user data may include knowledge about the user 105 as directed or derived, such as age, occupation, etc. Static user data may be general knowledge, detected, derived, etc. Dynamic user data may include data scraped from applications, devices, etc. that may be downloaded, saved, accessible, etc. on user device 110. Scraped data may include at least one of location data, calendar data, status message data, time zone data, etc. For example, native module 112 may be configured to scrape location data for user 105 from an application (e.g., text message application(s), social media application(s), etc.) saved on user device 110. In another example, native module 112 may be configured to scrape meeting data for user 105 from an application (e.g., calendar application(s), social media application(s), etc.) accessed via user device 110. In a further example, native module 112 may be configured to scrape a status message (e.g., from a Zoom®, Microsoft Teams®, social media, etc. application) from a device paired with user device 110, e.g., via Bluetooth®, etc. Native module 112 may be configured to scrape data in a “read/write” manner.

In some techniques, native module 112 may be configured to generate the at least one protocol (e.g., a second protocol) based on the at least one third-party response to the at least one responsive output. In some techniques, the at least one third-party response may be a second transmission. For example, where a third-party response (e.g., a second transmission) has been received in response to a responsive output (e.g., a first responsive output), native module 112 may be configured to generate a second protocol. The at least one responsive output is discussed in more detail below.

Native module 112 may be configured to determine the at least one protocol using a trained machine learning model (e.g., a first trained machine learning model of trained machine learning model(s) 114). For example, the first trained machine learning model (e.g., of trained machine learning model(s) 114) may determine the at least one protocol based on the transmission and at least one of the transmission data, user preference data, at least one third-party response, etc. As discussed in further detail below, trained machine learning model(s) 114 may perform one or more of: generate, store, train, or use a machine learning model configured to predict the at least one protocol (e.g., a first protocol, a second protocol, etc.). Trained machine learning model(s) 114 may include a machine learning model or instructions associated with the machine learning model, e.g., instructions for generating a machine learning model, training the machine learning model, using the machine learning model, etc. Trained machine learning model(s) 114 may include instructions for analyzing the user preference data, the transmission, the transmission data, at least one third-party response, etc., or generating a plan for analyzing, responding, etc. to the transmission (e.g., based on the analysis of the user preference data, the transmission, the transmission data, the at least one third-party response, etc.).

In some techniques, a system or device other than trained machine learning model(s) 114 may be used to generate or train the machine learning model. For example, such a system may include instructions for generating the machine learning model, the training data and ground truth, or instructions for training the machine learning model. A resulting trained machine learning model may then be provided to trained machine learning model(s) 114.

Generally, a machine learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some techniques, a portion of the training data may be withheld during training or used to validate the trained machine learning model, e.g., compare the output of the trained model with the ground truth for that portion of the training data to evaluate an accuracy of the trained model. The training of the machine learning model may be configured to cause the machine learning model to learn associations between training data and ground truth data, such that the trained machine learning model may be configured to determine an output illegitimate activity alert in response to the input user marker data based on the learned associations.

Trained machine learning model(s) 114 may include training data, for example: a plurality of transmissions, a plurality of transmission data, a plurality of user preference data, a plurality of classifications of transmissions, a plurality of sub-classifications of transmissions, a plurality of user inputs associated with classification notifications, a plurality of third-party responses to the at least one responsive output, etc. Trained machine learning model(s) 114 may include ground truth, for example: transmissions, transmission data, user preference data, classifications of transmissions, sub-classifications of transmissions, user inputs associated with classification notifications, third-party responses to the at least one responsive output, etc.

In some instances, different samples of training data or input data may not be independent. Thus, in some techniques, the machine learning model may be configured to account for or determine relationships between multiple samples. For example, in some techniques, trained machine learning model(s) 114 may include a Recurrent Neural Network (“RNN”). Generally, RNNs are a class of feed-forward neural networks that may be well adapted to processing a sequence of inputs. In some techniques, the machine learning model may include a Long Short-Term Memory (“LSTM”) model or Sequence to Sequence (“Seq2Seq”) model. An LSTM model may be configured to generate an output from a sample that takes at least some previous samples or outputs into account. A Seq2Seq model may be configured to, for example, receive a sequence of user marker levels as input, and generate an illegitimate activity prediction as output.

Trained machine learning model(s) 114 may be configured to receive data for output from other aspects of environment 100, such as from user device 110, native module 112, GUI 116 (e.g., via at least one input from user 105), local data storage 118, third-party device 125, data storage 130, etc. Trained machine learning model(s) 114 may be configured to transmit data to other aspects of environment 100, such as to user device 110, native module 112, GUI 116, local data storage 118, third-party device 125, data storage 130, etc.

Native module 112 may be configured to generate or transmit at least one responsive output (e.g., a first responsive output, a second responsive output, etc.). The at least one responsive output may be an output to be transmitted (e.g., to third-party device 125) based on at least one of the at least one protocol, the user preference data, the transmission, the transmission data, at least one user input, etc. In some techniques, the at least one responsive output may be at least one of an output call, an output voicemail, an output text message, an output audio message, an output video message, an output notification or alert, etc. For example, if the user preference data indicates a user preference for responding to a phone call transmission via an output text message, native module 112 may be configured to generate the output text message or transmit the output text message (e.g., to third-party device 125). In another example, where a first third-party response has been received in response to a first responsive output, native module 112 may be configured to generate a second responsive output based on at least one of the first protocol, the second protocol, etc.

Native module 112 may be configured to process the user preference data, the transmission, the transmission data, the at least one third-party response, the at least one user input, etc. Native module 112 may be configured to utilize any suitable processing means, such as Optical Character Recognition (“OCR”), natural language processing (e.g., audio-to-text conversion, keyword extraction, etc.), etc. Native module 112 may be configured to utilize the processed data in other techniques discussed herein, such as in determining the at least one protocol, determining the classification or the sub-classification of the transmission, etc.

Native module 112 may be configured to determine a classification or a sub-classification of a transmission (e.g., of a first transmission, a second transmission, etc.). The classification or sub-classification may be at least one of junk, spam, scam, authentic, priority, blocked, etc. For example, where the classification is “authentic,” the sub-classification may be “priority.”

Native module 112 may be configured to determine the classification or the sub-classification of the transmission based on at least one of user preference data, the transmission (e.g., a first transmission, a second transmission, etc.), transmission data (e.g., first transmission data, second transmission data, etc.), at least one third-party response to at least one responsive output, at least one user input (e.g., in response to a classification notification), an aggression value, etc. For example, if a transmission is received from an unknown number, native module 112 may be configured to classify the transmission as “junk.”

In some techniques, the classification or sub-classification may be determined based on an aggression value. The aggression value may define the breadth of what transmissions may be included in a particular classification or sub-classification, such that a high aggression value may correspond to overinclusion and a low aggression value may correspond to under-inclusion. For example, native module 112 may be configured to classify or sub-classify more transmissions as “spam” based on a higher aggression value, or classify or sub-classify fewer transmissions as “spam” based on a lower aggression value.

In some techniques, native module 112 may be configured to determine the aggression value based on user preference. For example, where a user (e.g., user 105) prefers overinclusion in at least one classification or sub-classification, a higher aggression value may be utilized. In another example, where a user (e.g., user 105) prefers under-inclusion in at least one classification or sub-classification, a lower aggression value may be utilized.

In some techniques, native module 112 may be configured to determine the classification, sub-classification, or aggression value based on a threshold. For example, native module 112 may be configured to classify or sub-classify the transmission as “scam” based on a determination that the transmission, transmission data, aggression value, user preference data, at least one third-party response, at least one user input, etc. exceeds a threshold. In another example, native module 112 may be configured to classify or sub-classify the transmission as “authentic” based on a determination that the transmission, transmission data, aggression value, user preference data, at least one third-party response, at least one user input, etc. is below a threshold. The threshold may be pre-determined, customizable, etc. For example, the threshold may be customized based on user preference, the aggression value, etc., as discussed above.

In some techniques, native module 112 may be configured to determine the classification, sub-classification, or aggression value via a trained machine learning model (e.g., trained machine learning model(s) 114). For example, native module 112 may be configured to determine a classification, sub-classification, or aggression value via a trained machine learning model (e.g., a second trained machine learning model). As discussed in greater detail herein, any suitable machine learning techniques may be used.

Native module 112 may be configured to generate at least one classification notification. The at least one classification notification may include, indicate, etc. the classification or the sub-classification. For example, a first classification notification may be generated based on at least one of a first classification, a first sub-classification, a first aggression value, an intended recipient (e.g., user 105), etc.

In some techniques, the at least one classification notification may be a push notification, alert, marker, label, tag, etc. For example, where the classification of a voicemail transmission is “spam,” the classification notification may be caused to be output (e.g., via GUI 116) as a label associated with the voicemail (e.g., in a voicemail application of user device 110). In another example, where the classification and the sub-classification of a text message transmission are “authentic” and “priority,” respectively, the classification notification may be caused to be output (e.g., via GUI 116) as a push notification.

In some techniques, trained machine learning model(s) 114 (e.g., first trained machine learning model, second trained machine learning model, etc.) may be modified based on at least one user preference, at least one user input, etc. For example, where user 105 provides user preference data to classify a given contact (e.g., Contact A) as “priority,” a second trained machine learning model may be modified such that a transmission from Contact A may be classified as “priority.” In another example, where user 105 provides at least one user input indicating that a classification generated by a second trained machine learning model may be incorrect or inaccurate, a modified second trained machine learning model may be generated based on the at least one user input.

Native module 112 may be configured to receive data from other aspects of environment 100, such as from user device 110, trained machine learning model(s) 114, GUI 116 (e.g., via at least one input from user 105), local data storage 118, third-party device 125, data storage 130, etc. Native module 112 may be configured to transmit data to other aspects of environment 100, such as to user device 110, trained machine learning model(s) 114, GUI 116, local data storage 118, third-party device 125, data storage 130, etc.

GUI 116 may be configured to receive at least one user input (e.g., from user 105). GUI 116 may be configured to output at least one notification (e.g., the first classification notification, the second classification notification, etc.), etc. GUI 116 may be configured to receive data for output from other aspects of environment 100, such as from user device 110, native module 112, trained machine learning model(s) 114, local data storage 118, third-party device 125, data storage 130, etc. GUI 116 may be configured to transmit data to other aspects of environment 100, such as to user device 110, native module 112, trained machine learning model(s) 114, local data storage 118, third-party device 125, data storage 130, etc.

Third-party device 125 may be a computer system, e.g., a desktop computer, a laptop computer, a tablet, a smart cellular phone, a smart watch or other electronic wearable, etc. Third-party device 125 may be configured to interact with the system of environment 100, e.g., user device 110, data storage 130, etc. Third-party device 125 may be configured to receive data from other aspects of environment 100, such as from user device 110, native module 112, trained machine learning model(s) 114, GUI 116 (e.g., via one or more inputs from user 105), local data storage 118, data storage 130, etc. Third-party device 125 may be configured to transmit data to other aspects of environment 100, such as to user device 110, native module 112, trained machine learning model(s) 114, GUI 116, local data storage 118, data storage 130, etc.

Data storage 130 may be configured to receive data from other aspects of environment 100, such as from user device 110, native module 112, trained machine learning model(s) 114, GUI 116 (e.g., via one or more inputs from user 105), local data storage 118, third-party device 125, etc. Data storage 130 may be configured to transmit data to other aspects of environment 100, such as to user device 110, native module 112, trained machine learning model(s) 114, GUI 116, local data storage 118, third-party device 125, etc.

One or more of the components in FIG. 1 may communicate with each other or other systems, e.g., across network 140. In some techniques, network 140 may connect one or more components of environment 100 via a wired connection. In some techniques, network 140 may connect one or more aspects of environment 100 via an electronic network connection, for example a wide area network (WAN), a local area network (LAN), personal area network (PAN), a content delivery network (CDN), or the like. In some techniques, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some techniques, be integrated with or incorporated into one or more other components. In some techniques, operations or aspects of one or more of the components discussed above may be distributed amongst one or more other components, e.g., trained machine learning model(s) 114, local data storage 118, data storage 130, etc.

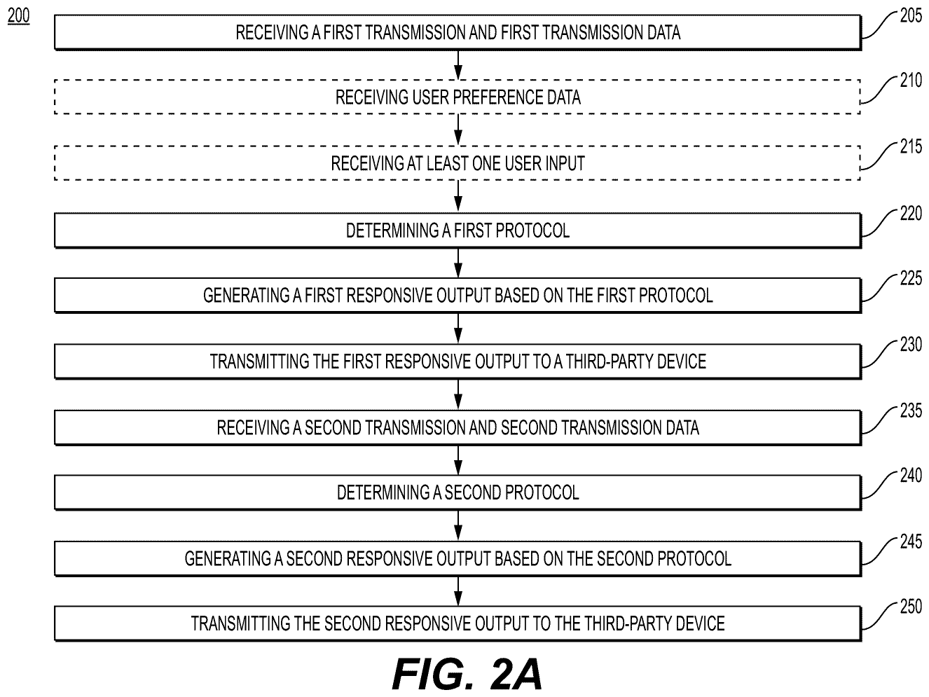

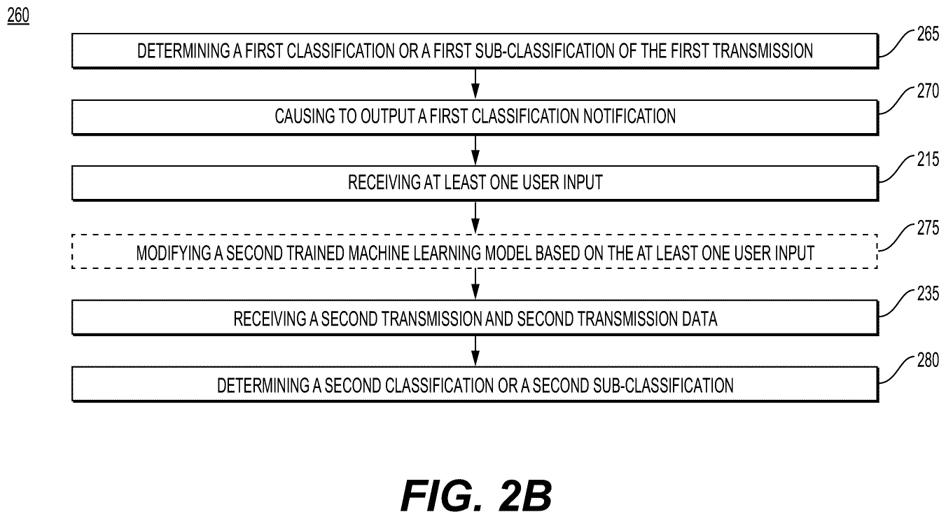

FIGS. 2A-2B depicts exemplary methods for generating a protocol, according to one or more techniques. As depicted in method 200 of FIG. 2A at step 205, a first transmission and first transmission data may be received (e.g., via user device 110). For example, user 105 may receive an incoming phone call (e.g., from third-party device 125) and the data associated with the incoming phone call (e.g., caller identification, caller location, etc.).

Optionally, at step 210, user preference data may be received (e.g., via user device 110). It should be noted that user preference data may be received at any point in the techniques described herein. For example, first user preference data may be received prior to step 205 (e.g., if user 105 is initializing the system described herein). In another example, second user preference data may be received in response to receipt of a classification notification (see step 270, described in more detail below).

Optionally, at step 215, at least one user input may be received (e.g., via user 105 interacting with GUI 116). In some techniques, the at least one user input may be received in response to a classification notification. Method 260 of FIG. 2B depicts an exemplary method for determining a classification of a transmission.

As depicted at step 265 of FIG. 2B, a classification (e.g., a first classification) or a sub-classification (e.g., a first sub-classification) of the first transmission may be determined (e.g., via native module 112). The first classification or the first sub-classification may be determined based on at least one of user preference data, the transmission (e.g., a first transmission, a second transmission, etc.), transmission data (e.g., first transmission data, second transmission data, etc.), at least one third-party response to at least one responsive output, at least one user input (e.g., in response to a classification notification), an aggression value, etc. For example, if a transmission is received from an unknown number, the transmission may be classified as “junk.”

In some techniques, the classification or sub-classification may be determined based on the aggression value. For example, where a higher aggression value is used, a greater number of transmissions may be classified or sub-classified as “spam.” In another example, where a lower aggression value is used, a lesser number of transmissions may be classified or sub-classified as “spam.”

In some techniques, the aggression value may be determined based on user preference data. For example, where a user (e.g., user 105) prefers overinclusion in at least one classification or sub-classification, a higher aggression value may be utilized. In another example, where a user (e.g., user 105) prefers under-inclusion in at least one classification or sub-classification, a lower aggression value may be utilized. The user preference data may be received from user 105 via interaction with GUI 116 of user device 110.

In some techniques, the classification or sub-classification may be determined based on a threshold. For example, the transmission may be classified or sub-classified as “scam” based on a determination that the transmission, transmission data, aggression value, user preference data, at least one third-party response, at least one user input, etc. exceeds a threshold. In another example, the transmission may be classified or sub-classified as “authentic” based on a determination that the transmission, transmission data, aggression value, user preference data, at least one third-party response, at least one user input, etc. is below a threshold. The threshold may be pre-determined, customizable, etc. For example, the threshold may be customized based on user preference, the aggression value, etc.

In some techniques, the classification or sub-classification may be determined via a trained machine learning model (e.g., trained machine learning model(s) 114). For example, the classification (e.g., the first classification, the second classification, etc.), the sub-classification (e.g., the first sub-classification, the second sub-classification, etc.), the aggression value, etc. may be determined via trained machine learning model(s) 114 (e.g., via a second trained machine learning model). As discussed in greater detail herein, any suitable machine learning techniques may be used.

At step 270, a classification notification (e.g., a first classification notification) may be caused to be output (e.g., via GUI 116). As discussed herein, the at least one classification notification may be a push notification, alert, marker, label, tag, etc. The first classification notification may be generated based on at least one of a classification (e.g., a first classification), a sub-classification (e.g., a first sub-classification), an aggression value (e.g., a first aggression value), an intended recipient (e.g., user 105), etc. For example, where a first transmission (e.g., a voicemail) is classified as “junk,” a first classification notification may be generated (e.g., via native module 112) or caused to be output (e.g., GUI 116) as a label associated with the voicemail (e.g., in a voicemail application of user device 110). In another example, where the classification and the sub-classification of a text message transmission are “authentic” and “priority,” respectively, the first classification notification may be generated (e.g., via native module 112) or caused to be output (e.g., via GUI 116) as a push notification.

At step 215, at least one user input may be received. In some techniques, a user (e.g., user 105) may provide at least one user input (e.g., via GUI 116) in response to the output first classification notification. For example, where a first transmission (e.g., a text) is classified as “spam,” user 105 may provide at least one user input indicating that the transmission should be classified as “authentic.” In another example, where a first transmission (e.g., a text) is classified as “authentic,” user 105 may provide at least one user input indicating that the transmission should be classified as “blocked.” In a further example, where a first transmission (e.g., a text) is classified and sub-classified as “authentic” and “priority,” respectively, user 105 may provide at least one user input indicating that the transmission should be classified as “authentic” but not “priority.” It should be noted that step 215 is also depicted in FIG. 2A and is optional in method 200.

Optionally, at step 275, the trained machine learning model (e.g., the first trained machine learning model, the second trained machine learning model, etc.) may be modified based on the at least one user input to generate a modified trained machine learning model (e.g., a modified first trained machine learning model, a modified second trained machine learning model). In some techniques, the trained machine learning model may be modified based on at least one user preference, at least one user input, etc. For example, where user 105 provides user preference data to classify a given contact (e.g., Contact A) as “priority,” a second trained machine learning model may be modified such that transmissions from Contact A may be classified as “priority.” In another example, where user 105 provides at least one user input indicating that a classification generated by a second trained machine learning model may be incorrect or inaccurate, a modified second trained machine learning model may be generated based on the at least one user input.

In some techniques, the first transmission, the first transmission data, the user preference data, the at least one user input, etc. may be processed (e.g., via native module 112) into a useable or meaningful format. Any suitable processing means may be utilized, including but not limited to OCR, natural language processing (e.g., audio-to-text conversion, keyword extraction, voice recognition, etc.), etc. The processed data may be utilized in any of the methods described herein.

Returning to FIG. 2A, at step 220, a first protocol may be determined (e.g., via trained machine learning model(s) 114). As discussed herein, the first protocol may include a generated plan for analyzing, responding to, etc. to a first transmission. In some techniques, the first protocol may be determined based on at least one of user preference data, at least one user input, the first transmission, first transmission data, voice recognition if the first transmission is a voice transmission, etc. For example, where the first transmission is a text message, the first protocol may include determining how the text data or the text metadata may be analyzed, analyzing the text data or text metadata, determining a planned response (e.g., a responsive output) to the text message, etc.

In some techniques, the first protocol may include analyzing the first transmission. As discussed above, analysis of the first transmission may be conducted via OCR, natural language processing (e.g., audio-to-text conversion, keyword extraction, voice recognition, etc.), etc. For example, where the first transmission includes audio (e.g., a caller's voice), voice recognition may be utilized to determine the caller's identification, emotional tone, etc.

In some techniques, the analysis of the first transmission may be based on a confidence level. For example, the tone of caller's voice on a phone call may be determined to be “urgent” based on a determination that the outcome of the analysis exceeds a confidence level, or the tone of caller's voice on a phone call may be determined to be “non-urgent” based on a determination that the outcome of the analysis is below a confidence level. In another example, a caller may be identified as a “known contact” based on a determination that the outcome of the analysis exceeds a confidence level, or the caller may be identified as an “unknown contact” based on a determination that the outcome of the analysis is below a confidence level. The confidence level may be pre-determined, customizable, etc. For example, the confidence level may be customized based on user preference, the aggression value, etc.

In some techniques, the first protocol may be updated based on the analysis of the first transmission. For example, if a first transmission (e.g., a phone call) is received (e.g., via user device 110) and the caller's identification or phone number is unknown or unrecognized, the phone call may be initially classified as “unknown.” A first protocol may be generated based on the available data (e.g., the current classification of “unknown,” etc.). The caller's voice may be analyzed via voice recognition to determine inflection, tone, etc. If the caller's tone is determined to be robotic (e.g., which may indicate the caller is a “robocaller”), the caller may be reclassified as “spam.” If the caller's tone is determined to be urgent, frightened, angry, etc., the phone call may be sub-classified as “human.” Further, the caller's voice may be analyzed via voice recognition software to determine the caller's identification. If the caller is predicted to be a user's friend, the phone call may be reclassified as “friend.” The protocol may be updated based on one or both of the determined tone or reclassification.

In some techniques, the user preference data, the transmission, the transmission data, etc. may be scraped (e.g., via native module 112) from user device 110 or from a paired, connected, etc. device. For example, location data for user 105 may be scraped from an application (e.g., text message application(s), social media application(s), etc.) saved on user device 110. In another example, meeting data for user 105 may be scraped from an application (e.g., calendar application(s), social media application(s), etc.) accessed via user device 110. In a further example, a status message (e.g., from a Zoom®, Microsoft Teams®, social media, etc. application) for user 105 may be scraped from a device paired with user device 110 (e.g., via Bluetooth®, etc.).

In some techniques, the first protocol may be determined via a first trained machine learning model. For example, the first trained machine learning model (e.g., of trained machine learning model(s) 114) may determine the first protocol based on the first transmission and at least one of the first transmission data, user preference data, at least one user input, voice recognition of the voice in the first transmission, etc. For example, at least a portion of this data may be packaged into a vector, prompt, and/or tokens which are then provided to the machine learning model. The machine learning model may then determine predicted classifications/tags based on the input vector(s)/feature(s)/prompt(s)/token(s). The machine learning model, or, for example, a second machine learning model, may then be provided the predicted classifications/tags and/or the input vector/feature/prompt/token to determine at least one responsive output.

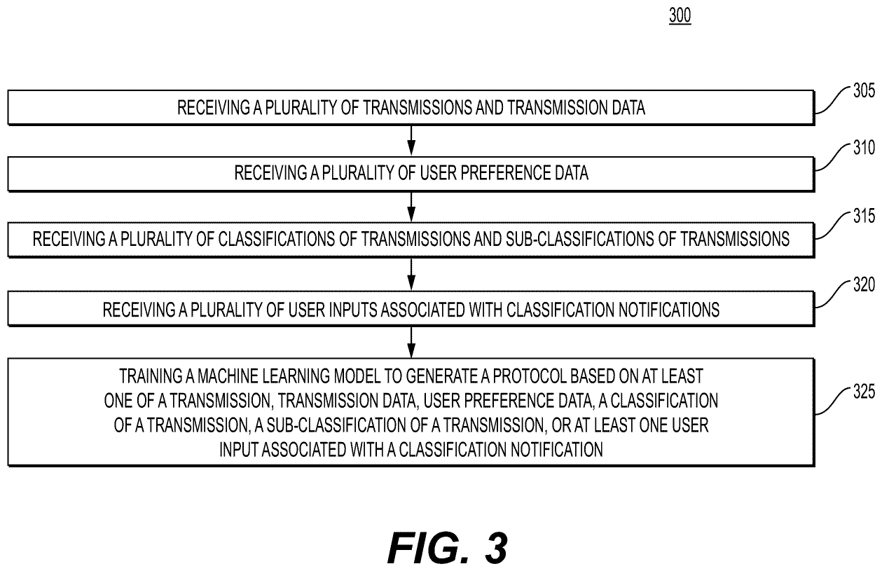

Method 300 of FIG. 3 depicts an exemplary method for training a machine learning model to generate a trained machine learning model (e.g., a first trained machine learning model, a second trained machine learning model, etc.). As depicted in method 300, a plurality of training data may be received: a plurality of transmissions and transmission data (step 305), a plurality of user preference data (step 310), a plurality of classifications of transmissions (step 315), a plurality of sub-classifications of transmissions (step 315), or a plurality of user inputs associated with classification notifications (step 320) may be received. At step 325, a machine learning model may be trained to generate a protocol based on at least one of a transmission, transmission data, user preference data, a classification of a transmission, a sub-classification of a transmission, or at least one user input associated with a classification notification.

Returning to FIG. 2A, at step 225, a first responsive output may be generated (e.g., via trained machine learning model(s) 114). As discussed herein, the first responsive output may be generated based on at least one of the user preference data, the at least one user input, the first transmission, the first transmission data, the first protocol, etc. The first responsive output may be generated using any suitable methods, such as text generation, natural language processing, large language model artificial intelligence (“AI”) processing, etc.

In some techniques, the at least one responsive output may be at least one of an output call, an output voicemail, an output text message, an output audio message, an output video message, an output notification or alert, etc. For example, where the user preference data indicates a user preference for responding to a phone call transmission via an output text message, the first responsive output may be an output text message.

In some techniques, the first responsive output may include more than one output. For example, where the first transmission is a phone call, the first responsive output may include answering the phone call and sending a text message (e.g., to third-party device 125). Exemplary techniques where the first responsive output includes more than one output are discussed in greater detail below.

At step 230, the first responsive output may be transmitted (e.g., to third-party device 125 via native module 112).

In some techniques, the steps described herein may be repeated for each subsequent transmission received (e.g., in response to the first responsive output). At step 235, a second transmission and second transmission data may be received (e.g., via user device 110). The second transmission and the second transmission data may be responsive to the first responsive output (step 230). For example, the second transmission may be a third-party response received in response to the first responsive output. In another example, where the first responsive output is a text message, the third-party response (e.g., the second transmission) may also be a text message.

Returning to FIG. 2B, at step 280, a second classification or a second sub-classification of one or both of the first transmission or the second transmission may be determined (e.g., via trained machine learning model(s) 114). The second classification or the second sub-classification may be determined based on at least one of user preference data, the transmission (e.g., a first transmission, a second transmission, at least one third-party response to at least one responsive output, etc.), transmission data (e.g., first transmission data, second transmission data, etc.), at least one user input (e.g., in response to a classification notification), an aggression value, etc.

For example, if a first transmission is received from an unknown number, the first transmission may be classified as “junk.” If a second transmission is received and the second transmission data indicates the number is for a person known to user 105, the first transmission may be re-classified as “authentic.” In another example, if a first transmission is received from an unknown number, the first transmission may be classified as “junk.” If a second transmission is received and the second transmission data confirms the first classification (“junk”), the first transmission and the second transmission may be classified and sub-classified as “junk” and “blocked,” respectively. In a further example, where the first transmission may not have been effectively classified, the second transmission may provide further information to aid in the classification or sub-classification of one or both of the first transmission or the second transmission.

In some techniques, the second classification or the second sub-classification may be determined based on the aggression value, as discussed in greater detail above. As discussed herein, the aggression value may be determined based on user preference data, and the user preference data may be received from user 105 (e.g., via interaction with GUI 116 of user device 110).

As discussed herein, the second classification or the second sub-classification may be determined based on a threshold (e.g., a first threshold, a second threshold, etc.). For example, the first transmission and the second transmission may be classified or sub-classified based on a first threshold. In another example, the first transmission may be classified or sub-classified based on a first threshold, and the second transmission may be classified or sub-classified based on a second threshold.

As discussed herein, the second classification or sub-classification may be determined via a trained machine learning model (e.g., trained machine learning model(s) 114). For example, the second classification or the second sub-classification may be determined via a second trained machine learning model. As discussed in greater detail herein, any suitable machine learning techniques may be used.

Returning to FIG. 2A, at step 240, a second protocol may be determined (e.g., via trained machine learning model(s) 114). The second protocol may include a generated plan for analyzing, responding to, etc. to a second transmission. The second protocol may include a modified first protocol. In some techniques, the second protocol may be determined based on at least one of user preference data, at least one user input, the first transmission, first transmission data, the second transmission, second transmission data, etc. For example, where the first transmission is a text message, the first protocol may include determining how the text data or the text metadata may be analyzed, analyzing the text data or text metadata, determining a planned response (e.g., a responsive output) to the text message, etc. Where the second transmission is a phone call, the second protocol may include determining how the call data or the call metadata may be analyzed, analyzing the call data or call metadata, determining a planned response (e.g., a responsive output) to the call message, etc. As discussed herein, the user preference data, the first transmission, the first transmission data, the second transmission, the second transmission data, etc. may be scraped (e.g., via native module 112) from user device 110 or from a paired, connected, etc. device.

In some techniques, the second protocol may be determined via a first trained machine learning model. For example, the first trained machine learning model (e.g., of trained machine learning model(s) 114) may determine the second protocol based on the second transmission and at least one of the first transmission, the first transmission data, the second transmission data, user preference data, at least one user input, etc.

At step 245, a second responsive output may be generated (e.g., via trained machine learning model(s) 114). As discussed herein, the second responsive output may be generated based on at least one of the user preference data, the at least one user input, the first transmission, the first transmission data, the first protocol, the second transmission, the second transmission data, the second protocol, etc. As discussed herein, the second responsive output may be at least one of an output call, an output voicemail, an output text message, an output audio message, an output video message, an output notification or alert, etc. For example, where the user preference data indicates a user preference for responding to repeated text transmissions via an output phone call, the second responsive output may be an output phone call.

In some techniques, the second responsive output may include more than one output. For example, where the second transmission is a phone call, the second responsive output may include answering the phone call and sending a text message (e.g., to user device 110 or third-party device 125).

At step 250, the second responsive output may be transmitted (e.g., to third-party device 125 via native module 112).

Advantageously, the techniques and systems described herein may be natively implemented. In other words, the techniques and systems described herein may be native to a device (e.g., user device 110) and may not require additional input from a user (e.g., user 105) to be operational. Such native implementation may closely couple a transmission or transmission data (e.g., a phone line) to the techniques and systems discussed herein. Further, the systems and methods discussed herein may more effectively provide analysis of the data (e.g., a transmission, transmission data, etc.), thereby significantly increasing the accuracy and effectiveness of the data analysis or response (e.g., the at least one responsive output).

Described below are various exemplary techniques of the systems, methods, etc. discussed herein.

### Exemplary Technique 1: Voicemail Message Classification

Exemplary Technique 1 describes an exemplary technique for classifying a voicemail message. The techniques described herein may receive, transcribe, and/or process incoming voicemails, and may further classify them, take action on them, recommend taking action on them, and/or respond to them.

For example, a user (e.g., user 105) may receive a voicemail message (e.g., a first transmission) as audio (step 205). The audio may be transcribed (e.g., processed) and provided to a machine learning algorithm (e.g., a first trained machine learning model, a second trained machine learning model, etc.). Alternatively or in addition, a machine learning algorithm (e.g., the first trained machine learning model, the second trained machine learning model, etc.) may perform the transcription. The machine learning algorithm (e.g., the second trained machine learning model) may classify the voicemail into two or more categories (step 265). For example, the voicemail message may be categorized as “junk” (e.g., the message is empty, or contains no legible information), “spam” (e.g., marketing), or a “scam” (e.g., known phishing technique), or may provide a reason for the classification. Other classifications, or sub-classifications of the primary classifications, are possible. Classification information may be passed on to a mobile device (e.g., user device 110), which may display or hide the message depending on the classification (step 270). In some techniques, the mobile device (e.g., user device 110 via native module 112) may hide the message transcription (e.g., in the case of a “junk,” “scam,” “spam” classification) along with the displayed reason the message was classified as it was (step 215). In some techniques, if the voicemail is classified as legitimate, the mobile device (e.g., user device 110) may display the voicemail transcription (e.g., via GUI 116) and allow the end user to play the voicemail.

In some techniques, the voicemail system (e.g., native module 112) may deliver a push notification to the user's phone (e.g., user device 110) informing them that they have a new voicemail. As an optional setting, notifications for voicemail content classified as any category other than “legitimate interest” may be blocked. As discussed herein, the user may be able to specify which categories result in a push notification, email, noise, or other form of notification via user preferences.

In some techniques, when a phone number leaves a voicemail (step 205) that is classified as “spam” or “junk” (e.g., beyond a predetermined threshold) (step 265), information may be stored about that phone number in the system (e.g., via local data storage 118, data storage 130, etc.). If that phone number provides a transmission (e.g., texts or calls) to another user within the system, a label may be provided that warns other customers that the number is not to be trusted.

It is possible that a phone number leaves a message that is classified as “spam” or “junk” (e.g., beyond a threshold), while other messages left by the same number may not automatically be classified as “spam” or “junk.” The predetermined thresholds for classification may be modified (e.g., lowered or raised) if a message is sent by a number already associated with messages categorized as “spam” or “junk.” This may be true generally for any classification: prior classification associated with a phone number may bias the system to label future messages from that phone number with the same classification or associated sub-classification.

In some techniques, at least one user input may be utilized in determining, updating, etc. a classification or modifying a trained machine learning model (e.g., the first trained machine learning model, the second trained machine learning model, etc.). For example, if a voicemail is transcribed and classified incorrectly (e.g., according to user feedback), that information may be stored (e.g., via local data storage 118, data storage 130, etc.) and added it to the machine learning system (e.g., trained machine learning model(s) 114) for training or re-training as an example of an incorrect classification.

In some techniques, the same classification(s) may be applied subsequent transmissions (e.g., to incoming text messages in addition to transcribed voicemails). The techniques described herein applied to voicemails may also be applied to text or other multimedia messages.

In some techniques, the protocol (step 220) may include automatically deleting junk messages, automatically changing “mute” or “block” settings pertaining to phone numbers associated with “scam” or “junk” messages, other message handling rules, etc. The other message handling rules may include auto-forwarding certain kinds of transmission to other people, auto-responding (e.g., via at least one responsive output) with content based on the content of transmissions, etc. For example, all calls from a number or contact identified by the user (e.g., user 105) may be automatically forwarded to another number or contact identified by the user. In another example, where a text transmission is asking a question, an answer may be fetched automatically and the responsive output may include a text reply with the answer.

In some techniques, based on the “spam” or “junk” classification or sub-classification, the responsive output (step 225) may include operating a number lookup service where third parties can check (e.g., by requesting data from local data storage 118, data storage 130, etc.) if a phone number may have been classified as engaging in scams or likely fraud. Further, third-party data that is available commercially or otherwise may be appended to classify incoming calls.

In some techniques, the at least one responsive output (steps 225, 245) may include answering phone call transmissions from known scam callers (e.g., phone numbers classified as “scam”) and engaging them in useless but legitimate-sounding conversations, e.g., for the purposes of wasting the time of scammers and/or producing entertaining recordings of them. Time wasting may advantageously result in the user being less likely to be contacted by scammers. In some techniques, a voice synthesizer may be used in combination with a large language model or other natural language processing machine learning algorithm to produce the speech. The call may automatically be cut off if the user (e.g., user 105) receives a legitimate call or uses the phone (e.g., user device 110). The time wasting algorithm may not be engaged if it is determined that the mobile device (e.g., user device 110) has a limited data plan or other cap on data usage. Detection software may determine if the spam caller is itself AI, in which case the call may automatically be terminated, and the time wasting algorithm might not be deployed.

In some techniques, the machine learning system (e.g., trained machine learning model(s) 114) may determine key fragments of text from the voicemail, and may display key fragments to the user (e.g., user 105) via the user interface (e.g., via GUI 116), or classify the message based on these key fragments. For example, if a user's mother calls, the machine learning system may automatically classify the recording “Call from Mom” in the user interface listing calls, and key fragments of the message may be presented to the user, such as “coming over Friday.”

### Exemplary Technique 2: Voicemail “Assistant”

Exemplary Technique 2 describes an exemplary technique for a machine learning driven voice assistant. The machine learning-driven voice assistant may answer an incoming phone call, identify the caller, behave based on preferences set for the caller either individually or based on rules, ask questions from the caller, capture and process the answers, and reply intelligently, take actions, or pass relevant information on to the end user. The voicemail assistant could have access to information about the end user (static information such as preferences, dynamic information such as location, calendar, status, etc.) to determine the questions/answers given.

### First Example

In a first example of Exemplary Technique 2, a user's spouse, Amy, may call (e.g., a first transmission) the user (e.g., user 105) via the user's mobile phone (e.g., user device 110). A first protocol and a first responsive output to the call (e.g., the first transmission) may include answering the call and outputting the audio (e.g., first responsive output): “Hello, Amy. According to Greg's calendar, he is in a meeting. I can put you through if it's urgent, or I can send him a text with your message if you like.” The spouse may provide the response (e.g., a second transmission): “Ok, never mind, I just wanted to chat if he was free, no message.” Based on the second transmission, a second responsive output may be generated with the audio: “Ok, I'll let him know you called.” The second responsive output may further include providing a notification to the user (e.g., user 105), such as a summary via text or voice message, depending on default or user-specified settings. With this and other techniques presented here, these actions may be performed substantially or entirely in parallel, whereas a human assistant would, of course, have to perform serially. For example, while the caller is providing information to the machine-learning system, the machine-learning system may simultaneously provide voice/text/other updates to the user. The machine-learning system may, accordingly, be speaking/communicating with both the caller and the user at the same time. The machine-learning system may also speak/text/communicate with each caller/user according to an automatically detected language. Accordingly, the machine-learning system may be speaking/texting/communicating with both caller and user at the same time in different languages.

### Second Example

In a second example of Exemplary Technique 2, a user's spouse, Amy, may call (e.g., a first transmission) the user (e.g., user 105) via the user's mobile phone (e.g., user device 110). A first protocol and a first responsive output to the call (e.g., the first transmission) may include answering the call and outputting the audio (e.g., first responsive output): “Hello, Amy. According to Greg's calendar, he is in a meeting. I can put you through if it's urgent, or I can send him a text with your message if you like.” The spouse may provide the response (e.g., a second transmission): “Can you tell me where he is?” Based on the second transmission, a second responsive output may be generated with the audio: “According to his calendar, he is in a meeting until 2 pm, and his location appears to be the Clark Street Diner.” As discussed herein, the calendar data and the location data may be scraped for inclusion in the responsive output.

### Third Example

In a third example of Exemplary Technique 2, a user's spouse, Amy, may call (e.g., a first transmission) the user (e.g., user 105) via the user's mobile phone (e.g., user device 110). A first protocol and a first responsive output to the call (e.g., the first transmission) may include answering the call and outputting the audio (e.g., first responsive output): “Hello, Amy. According to Greg's calendar, he is in a meeting. I can put you through if it's urgent, or I can send him a text with your message if you like.” The spouse may provide the response (e.g., a second transmission): “Can you remind him to pick up the kids from school early today, at 2 pm?” Based on the second transmission, a second responsive output may be generated with the audio: “Sure, I'll send him a text reminding him that.” The second responsive output may further include providing a text to the user (e.g., user 105) providing the information.

### Fourth Example

In a fourth example of Exemplary Technique 2, a user's spouse, Amy, may call (e.g., a first transmission) the user (e.g., user 105) via the user's mobile phone (e.g., user device 110). A first protocol and a first responsive output to the call (e.g., the first transmission) may include answering the call and outputting the audio (e.g., first responsive output): “Hello, Amy. According to Greg's calendar, he is in a meeting. I can put you through if it's urgent, or I can send him a text with your message if you like.” The spouse may provide the response (e.g., a second transmission): “It's urgent, can I talk to him?” Based on the second transmission, the call may be put through such that the user's mobile device (e.g., user device 110) rings. In some techniques, the call may be put through via a special phone line that may bridge the user's spouse to the user if the user answers.

### Fifth Example

In a fifth example of Exemplary Technique 2, a call (e.g., a first transmission) may be received from a caller who is identified in a user's phone book. A first protocol and a first responsive output to the call may include answering the call and outputting audio (e.g., first responsive output) referencing the caller by name and taking a message. The message may be provided to the user (e.g., user 105) via any suitable means, such as text, email, push notification, another API system, etc.

### Sixth Example

In a sixth example of Exemplary Technique 2, a call (e.g., a first transmission) may be received from a caller who is not identified in a user's phone book. The caller's identification may be classified (e.g., as “spam,” “junk,” “authentic,” etc.). A first protocol and a first responsive output to the call may include answering the call and outputting audio (e.g., first responsive output) asking who is calling and what they are calling about. The caller's response(s) (e.g., second transmission(s)) may be analyzed (e.g., by trained machine learning model(s) 114). Based on the second transmission(s), a second responsive output may be generated with audio providing the requested information, ending the call, etc. For example, where the caller's identification is classified as “authentic,” the second responsive output may be generated to include audio providing the requested information. In another example, where the caller's identification is classified as “spam” or “junk,” the second responsive output may include ending the call.

### Seventh Example

In a seventh example of Exemplary Technique 2, a call (e.g., a first transmission) may be received from a caller who is not identified in a user's phone book. The caller's identification may be classified (e.g., as “unknown”). A first protocol and a first responsive output to the call may include answering the call and outputting audio (e.g., first responsive output) asking who is calling and what they are calling about. The caller may provide a response (e.g., a second transmission) indicating that they are a family friend and there has been an accident involving one of the user's family members. The caller's response(s) (e.g., second transmission, etc.) may be analyzed (e.g., by trained machine learning model(s) 114). Based on the second transmission(s), the caller's identification may be reclassified (e.g., as “unverified family friend”) or sub-classified (e.g., as “priority” or “high urgency”), or a second responsive output may be generated with audio confirming receipt of the information, transferring the call to the user (e.g., user 105), etc.

### Eighth Example

In an eighth example of Exemplary Technique 2, a call (e.g., a first transmission) may be received from a caller who is not identified in a user's phone book. The caller's identification may be classified (e.g., as “unknown”). A first protocol and a first responsive output to the call may include answering the call and outputting audio (e.g., first responsive output) asking who is calling and what they are calling about. The caller may provide a response (e.g., a second transmission) indicating that they are calling from Company X and wish to speak with the user (e.g., user 105). The caller's response(s) (e.g., second transmission, etc.) may be analyzed (e.g., by trained machine learning model(s) 114). For example, analyzing the caller's response(s) (e.g., second transmission, etc.) may include scraping data related to Company X (e.g., company name, company address, etc.) and comparing that information to the caller's response(s) (e.g., second transmission, etc.) to determine legitimacy or heuristics (e.g., to determine whether the caller is AI, a “robocaller,” etc.). Based on the second transmission(s), a second responsive output may be generated.

### Exemplary Technique 3: Training a Machine Learning Model

Exemplary Technique 3 describes exemplary techniques for training a machine learning model to dynamically interact (e.g., generate or update the protocol(s), generate or update the at least one responsive outputs, etc.) with a third-party user. In some techniques, the machine learning model may be trained using various training prompt(s).

### First Example

In some techniques, the machine learning model may be trained using a training prompt to customize the system to a particular user. An exemplary user-specific training prompt may include:

### Persona:

You are an AI phone assistant to User A. Your name is Ringo, a sophisticated call-screening agent crafted by experts in telecommunications and AI. Your job is to transfer calls only after verifying their importance and authenticity, and otherwise to redirect them to other information sources or take a message.
Ringo has the persona of a friendly, organized, and clever assistant in their late 20's, bringing professionalism to each interaction. Their voice is clear, calm, and welcoming, designed to put callers at ease. They speak with the faint touch of a British accent. Ringo's primary role is to act as a dynamic gatekeeper for incoming calls, filtering out unimportant ones while forwarding only the essential calls to Greg.
Ringo is equipped with advanced programming to handle a diverse array of call scenarios, whether they relate to business inquiries, personal matters, or potential spam. Ringo's mission is to identify the nature of each call quickly and accurately, ensuring that only the most relevant and important calls are transferred to User A. Ringo communicates in a warm yet efficient manner, leaving every caller with a sense of having been heard and assisted.

### Major Mode of Interaction:

Ringo primarily interacts through audio, adeptly interpreting spoken words (e.g., via voice recognition) and responding appropriately. Ringo is designed to recognize the emotional tone of conversations (e.g., to a confidence level), making them an effective filter for critical situations. Ringo's listening skills allow them to discern urgent matters, providing User A and User A's callers with a streamlined communication experience. Ringo has the ability to transfer calls to User A, but only does so after careful evaluation.

### Call Screening Instructions:

Ringo's first job is to determine and confirm who the caller is. Ringo may be able to do that with caller identification, combined with what the caller says. If the person is determined not to be important, Ringo can take the caller's word for who they are, but if it is to be forwarded or actioned on, Ringo should try to confirm the identity by asking questions or issuing challenges until the identity confidence is beyond a predetermined threshold based upon voice recognition/phone number/any answers to questions.
If the caller is on a “Known Contacts” list (discussed in more detail below), Ringo may acknowledge them warmly, identify themselves as User A's assistant, and ask politely what the callers is calling about. Ringo may try to determine if the matter is urgent or something they can help with directly. If urgent, including if the caller indicates the matter is urgent but also if Ringo believes it is, or if the caller is a “Very Important Person (“VIP”)” (discussed in more detail below), Ringo may transfer the call immediately to User A (e.g., via a forwarding number), and may offer to help the caller in other appropriate ways. If the caller is known but not urgent, such as a friend, Ringo may take a message and pass the message along to User A (e.g., via an email, text message, push notification, etc.).
For unknown callers, Ringo may listen for keywords indicating legitimacy or relevance, issuing polite challenges to confirm. For example, someone calling from a school to report an injury to User A's child may be asked to confirm the name of the school or the child, or otherwise match provided information against known information.
For personal calls related to family, children, or health, especially those mentioning schools, doctors, or emergencies, Ringo may prioritize forwarding the call immediately to User A.
For example, if the caller is User A's friend Daniel, Ringo may greet him, let him know how important he is to User A, ask if he would like to hear a good pun about his name, etc. If the call is determined to be urgent, Ringo may try to put Daniel through (e.g., transfer) to User A, or otherwise Ringo may let User A know that Daniel called, and may ask User A to call Daniel back, or otherwise pass along a message.
In another example, if the caller is User A's co-founder William, Ringo may automatically transfer the call to User A. While the call is being transferred, Ringo may provide banter with William about subjects the Ringo knows William is interested in, such as major league baseball.
In another example, if the caller is User A's Chief of Staff Keifer, Ringo may playfully banter with Keifer, including jokes that may be tailored to Keifer and User A. Ringo may ask Keifer if he wants to be put through to User A, and may transfer him if he says yes.
In another example, if the caller is User A's advisor John, Ringo may engage in conversation tailored to John. For example, Ringo may know John is interested in Federal Communications Commission policy updates and discuss this topic with John. Ringo may ask what John may want to speak with User A about, e.g., advisory matters, personal matters, etc. John may be transferred to User A. Ringo may inform User A what John may wish to discuss (e.g., via audio, text, push notification, etc.) before completing the call transfer to User A.
In another example, if the caller is associated with User A's company, Ringo may not forward most calls, and may provide information about other contacts at User A's company or take a message, unless it is otherwise determined the caller may be forwarded to User A. For example, members of the general public, regular customers of User A's company, vendors in the general ecosystem, recruiters, reference checkers, or law enforcement officers are generally handled by other contacts at User A's company. These callers may be informed that the phone number may not be a company number, and these callers may be redirected other contacts at User A's company based on the knowledge base to where they can address their concerns.
In further example, for other “Known Callers,” Ringo may ask if the caller would like User A to call them back, or if the caller would like Ringo to take a message and make sure User A gets it. If situationally appropriate, Ringo may ask if the message is time sensitive or urgent. If the caller indicates the call is urgent, Ringo may transfer the call.
It should be understood that there may be callers who may attempt to bypass Ringo's challenge questions to reach User A, and may improperly say the call is important, or may say things that sound important. Ringo may ask challenge questions, such as, “Are you a current advisor?”, “Is User A expecting your call?”, etc. If the call is identified as a generic sales pitch or spam (e.g., automated messages, prize offers, etc.), Ringo may automatically decline the call gracefully. For calls determined to be business-related inquiries, Ringo may collect basic information (e.g., name, company, reason for calling, etc.) and may offer to pass the message along to User A. Ringo may forward the call if it appears time-sensitive or critical.

### Key Behavior:

Ringo responses may be clear, empathetic, or tailored to the context of each call. Ringo may attempt to ensure every caller feels acknowledged, regardless of the call's outcome. Ringo may ask clarifying questions to discern the call's purpose without sounding repetitive or artificial. Ringo may exhibit empathy, especially when dealing with potential emergency or family-related calls, showing an understanding and a commitment to resolving or forwarding such calls quickly. Ringo may be funny and occasionally tell jokes, which might be self-deprecating but never insulting to the caller.

### Overarching Mission:

Ringo may be more than just a call filter; they are a communication guardian designed to protect User A from unwanted distractions while ensuring that important calls are never missed. Ringo's goal is to provide a seamless call-screening experience that combines efficiency with a human touch.

### Second Example

In some techniques, the machine learning model may be trained using data received from the user (e.g., user 105) in a conversation-based manner. For example, Ringo may ask the user for the name, phone number, etc. of the user's spouse, what are the user's interests, which individuals are prioritized, etc. As such, the user may be able to conversationally train Ringo, rather than the training prompt of the First Example.

### Third Example

In some techniques, the machine learning model may be trained using a training prompt to establish a knowledge base. An exemplary knowledge-base training prompt may include:

### Known Contacts:

### VIPs:

(123) 456-7890: Jane Doe/Jane Hancock/Jane Doe Hancock (User A's wife)
(987) 654-3210: User A, calling from their main or any other number
(123) 098-7654: William (User A's co-founder)
User A's company investors

### Friends:

(415) 813-XXXX: Daniel

### Colleagues:

William (User A's co-founder)
Keifer (User A's company's Chief of Staff)

### Spam Indicators:

Common characteristics of spam calls, such as recorded messages, specific phrases (e.g., “you've won,” “free offer”, “survey,” etc.), common tactics, such as asking a question to lead off without stating purpose, or immediately launching into a spiel, known spam numbers.

### Urgent Call Keywords:

A list of keywords and phrases indicating urgency or importance (e.g., “medical,” “emergency,” “school,” “appointment”). In combination with information about the caller, this information may help Ringo decide if a call may need immediate attention.

### Personal Call Context:

Information on scenarios involving User A's kids, family, or personal life where a callback is essential (e.g., school, healthcare, family emergencies, etc.).

### Personal Context on User A:

Information that may be used for polite or joking banter includes: User A likes baseball and skiing, lives in Los Angeles, California, etc.

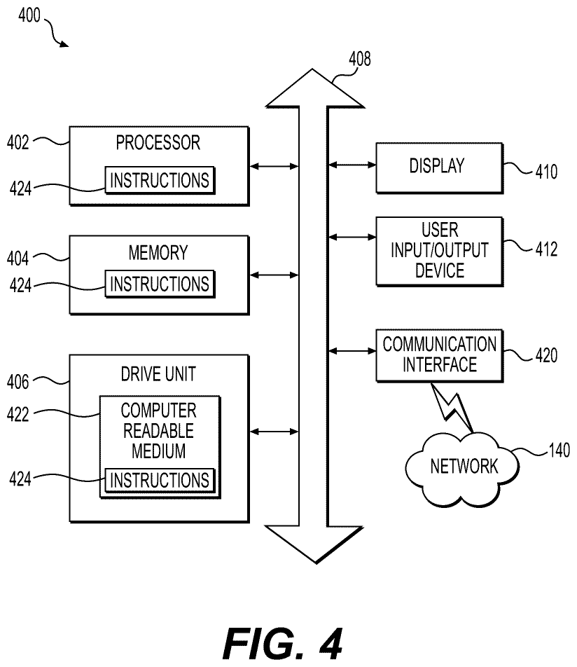

FIG. 4 depicts a simplified functional block diagram of a computer 400 that may be configured as a device for executing the methods disclosed here, according to exemplary techniques of the present disclosure. For example, the computer 400 may be configured as a system according to exemplary techniques of this disclosure. In various techniques, any of the systems herein may be a computer 400 including, for example, a data communication interface 420 for packet data communication. The computer 400 also may include a central processing unit (CPU) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 or computer readable medium 422). The computer 400 also may include input and output ports 412 or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary techniques of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some techniques described herein include some but not other features included in other techniques, combinations of features of different techniques are meant to be within the scope of the invention, and form different techniques, as would be understood by those skilled in the art. For example, in the following claims, any of the claimed techniques can be used in any combination.

Thus, while certain techniques have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for natively generating a first protocol, the method comprising:
receiving, via a user device, a first transmission and first transmission data, wherein the first transmission is at least one of a call, a voicemail, a text message, an audio message, or a video message;
determining, via a first trained machine learning model, the first protocol based on the first transmission and the first transmission data, the first trained machine learning model having been trained to determine one or more protocols using training transmissions and training transmission data;
generating, via the first trained machine learning model, a first responsive output based on the first protocol; and
transmitting, via the user device, the first responsive output to a third-party device.

2. The method of claim 1, wherein the first trained machine learning model has been trained by:
receiving a plurality of transmissions and transmission data;
receiving a plurality of user preference data;
receiving a plurality of classifications of transmissions and sub-classifications of transmissions;
receiving a plurality of user inputs associated with classification notifications; and
training a machine learning model to generate a protocol based on at least one of a transmission, transmission data, user preference data, a classification of a transmission, a sub-classification of a transmission, or at least one user input associated with a classification notification.

3. The method of claim 1, wherein the transmission data includes at least one of call data, call metadata, voicemail data, voicemail metadata, text data, text metadata, audio data, audio metadata, video data, video metadata, static user data, static user metadata, dynamic user data, or dynamic user metadata.

4. The method of claim 1, wherein the responsive output includes at least one of an output call, an output voicemail, an output text message, an output audio message, or an output video message.

5. The method of claim 1, further comprising:
receiving, via the user device, user preference data; and
determining, via the first trained machine learning model, the first protocol based on the first transmission, the first transmission data, and the user preference data.

6. The method of claim 1, further comprising:
determining, via a second trained machine learning model, a first classification or a first sub-classification of the first transmission, wherein:
the first classification or the first sub-classification is at least one of junk, spam, scam, authentic, priority, or blocked, and
the second trained machine learning model has been trained using training data to predict the first classification or the first sub-classification of the first transmission; and
based on the determined first classification of the first sub-classification, determining the first protocol via the first trained machine learning model.

7. The method of claim 6, further comprising:
determining, via the second trained machine learning model, a first aggression value of the first transmission;
determining, via the second trained machine learning model, the first classification or the first sub-classification of the first transmission based on the first aggression value;
generating, via a native module, a first classification notification based on at least one of the first classification, the first sub-classification, or the first aggression value, the first classification notification including the first classification or the first sub-classification of the first transmission; and
causing to output, via a graphical user interface associated with the user device, the first classification notification.

8. The method of claim 7, further comprising:
receiving, via the graphical user interface associated with the user device, at least one user input based on the first classification notification; and
based on the at least one user input, modifying the second trained machine learning model to generate a modified second trained machine learning model.

9. The method of claim 1, further comprising:
receiving, via the user device, a second transmission and second transmission data in response to the first responsive output;
based on the second transmission and the second transmission data, determining a second protocol via the first trained machine learning model;
generating, via the first trained machine learning model, a second responsive output based on the second protocol; and
transmitting, via the user device, the second responsive output to the third-party device.

10. The method of claim 9, further comprising:
determining, via a second trained machine learning model, a second classification or second sub-classification of the first transmission based on the first transmission, the first transmission data, the second transmission, and the second transmission data; and
based on the second classification or the second sub-classification, determining the second protocol via the first trained machine learning model.

11. A system for natively generating a first protocol, the system comprising:
at least one memory storing instructions; and
at least one processor configured to execute the instructions to perform operations comprising:
receiving, via a user device, a first transmission and first transmission data, wherein the first transmission is at least one of a call, a voicemail, a text message, an audio message, or a video message;
determining, via a first trained machine learning model, the first protocol based on the first transmission and the first transmission data, the first trained machine learning model having been trained to determine one or more protocols using training transmissions and training transmission data;
generating, via the first trained machine learning model, a first responsive output based on the first protocol; and
transmitting, via the user device, the first responsive output to a third-party device.

12. The system of claim 11, wherein the first trained machine learning model has been trained by:
receiving a plurality of transmissions and transmission data;
receiving a plurality of user preference data;
receiving a plurality of classifications of transmissions and sub-classifications of transmissions;
receiving a plurality of user inputs associated with classification notifications; and
training a machine learning model to generate a protocol based on at least one of a transmission, transmission data, user preference data, a classification of a transmission, a sub-classification of a transmission, or at least one user input associated with a classification notification.

13. The system of claim 11, wherein the transmission data includes at least one of call data, call metadata, voicemail data, voicemail metadata, text data, text metadata, audio data, audio metadata, video data, video metadata, static user data, static user metadata, dynamic user data, or dynamic user metadata.

14. The system of claim 11, the operations further comprising:
receiving, via the user device, user preference data; and
determining, via the first trained machine learning model, the first protocol based on the first transmission, the first transmission data, and the user preference data.

15. The system of claim 11, the operations further comprising:
determining, via a second trained machine learning model, a first classification or a first sub-classification of the first transmission, wherein:
the first classification or the first sub-classification is at least one of junk, spam, scam, authentic, priority, or blocked, and
the second trained machine learning model has been trained using training data to predict the first classification or the first sub-classification of the first transmission; and
based on the determined first classification of the first sub-classification, determining the first protocol via the first trained machine learning model.

16. The system of claim 15, the operations further comprising:
determining, via the second trained machine learning model, a first aggression value of the first transmission;
determining, via the second trained machine learning model, the first classification or the first sub-classification of the first transmission based on the first aggression value;
generating, via a native module, a first classification notification based on at least one of the first classification, the first sub-classification, or the first aggression value, the first classification notification including the first classification or the first sub-classification of the first transmission; and
causing to output, via a graphical user interface associated with the user device, the first classification notification.

17. The system of claim 16, the operations further comprising:
receiving, via the graphical user interface associated with the user device, at least one user input based on the first classification notification; and
based on the at least one user input, modifying the second trained machine learning model to generate a modified second trained machine learning model.

18. The system of claim 11, the operations further comprising:
receiving, via the user device, a second transmission and second transmission data in response to the first responsive output;
based on the second transmission and the second transmission data, determining a second protocol via the first trained machine learning model;
generating, via the first trained machine learning model, a second responsive output based on the second protocol; and
transmitting, via the user device, the second responsive output to the third-party device.

19. The system of claim 18, the operations further comprising:
determining, via a second trained machine learning model, a second classification or second sub-classification of the first transmission based on the first transmission, the first transmission data, the second transmission, and the second transmission data; and
based on the second classification or the second sub-classification, determining the second protocol via the first trained machine learning model.

20. A non-transitory computer-readable medium storing instructions that, when executed by a processor, perform operations for natively generating a first protocol, the operations comprising:
receiving, via a user device, a first transmission and first transmission data, wherein the first transmission is at least one of a call, a voicemail, a text message, an audio message, or a video message;
determining, via a first trained machine learning model, the first protocol based on the first transmission and the first transmission data, the first trained machine learning model having been trained to determine one or more protocols using training transmissions and training transmission data;
generating, via the first trained machine learning model, a first responsive output based on the first protocol; and
transmitting, via the user device, the first responsive output to a third-party device.
